(19) United States
(12) Patent Application Publication
(10) Pub. No.: US 2012/0255384 A1
(43) Pub. Date: Oct. 11, 2012

(54) DEVICE WITH A TRANSMISSION TO SUPPORT AT LEAST ONE AUXILIARY DEVICE OF A VEHICLE WITH DRIVE ENERGY

(75) Inventors: Frank-Detlef SPECK, Langenargen (DE); Alexander BANERJEE, Oberteuringen (DE)

(73) Assignee: ZF FRIEDRICHSHAFEN AG, Friedrichshafen (DE)

(21) Appl. No.: 13/433,585

(22) Filed: Mar. 29, 2012

(30) Foreign Application Priority Data
Apr. 11, 2011 (DE) 10 2011 007 143.1

(51) Int. Cl. F16H 1/04; F16H 15/38; F16H 1/28; F16H 1/00; F16H 7/00

(52) U.S. Cl. 74/412 R; 74/640; 474/148; 475/331; 476/40

(57) ABSTRACT

A mechanism with a transmission device for supplying at least one auxiliary power take-off aggregate of a vehicle with drive energy. A transmission ratio of the transmission device is varied continuously varied at least over a certain range and the transmission device can be brought into functional connection, on the input side, with a drive input of a drive machine of a drive-train of the vehicle and, on the output side, with the auxiliary power take-off aggregate. The transmission device is in the form of a mechanical transmission device. A transmission unit is provided in the power path between the drive machine and the auxiliary power take-off aggregate, whose transmission ratio is adapted to the mechanical transmission device in such manner that, in a main operating range, the mechanical transmission device can be operated essentially within the range of its maximum efficiency.

This application claims priority from German patent application serial no. 10 2011 007 143.1 filed Apr. 11, 2011.

### FIELD OF THE INVENTION

The invention concerns a mechanism with a transmission device for supplying at least one auxiliary power take-off aggregate of a vehicle with drive energy.

### BACKGROUND OF THE INVENTION

Vehicles known from practice, such as trucks, are built with numerous different so-termed auxiliary power take-off aggregates which are designed to carry out a variety of functions. Among others, to avoid deterioration of foods during transport, foods are transported in so-termed refrigerator trailers, inside which a transport temperature is set and maintained at a predefined temperature level by a cooling aggregate. To provide the energy required for this, a generator that supplies the cooling aggregate with electrical energy is usually functionally connected to a vehicle drive-train by way of a hydraulic, continuously variable transmission device, and is provided with the necessary drive power by a drive machine. In the area of the hydraulic continuously variable transmission device, the rotational speed of the drive machine, preferably in the form of an internal combustion engine, is continuously converted in order to operate the generator with a constant speed of around 3,000 revolutions per minute and to be able to supply the cooling aggregate with a constant alternating current at a voltage of 380 volts and a frequency of 50 hertz.

As is known, hydraulic continuously variable transmission devices are as a rule characterized by a poor efficiency of around 70%, and for that reason, during the cooling operation that must be continuously maintained in the area of a refrigerator trailer during transport, substantial power losses occur, which cause an undesirably high increase of fuel consumption in the area of the drive machine.

### SUMMARY OF THE INVENTION

Accordingly, the purpose of the present invention is to provide a mechanism with a continuously variable transmission device by means of which at least one auxiliary power take-off aggregate of a vehicle can be supplied with drive energy, and which can be operated with good efficiency.

In the mechanism according to the invention having a transmission device for supplying at least one auxiliary power take-off aggregate of a vehicle with drive energy, a transmission ratio of the transmission device can be varied continuously at least over a certain range. Furthermore, on its input side the transmission device is frictionally connected to a drive of a drive machine of a drive-train of the vehicle, and on its output side to the auxiliary power take-off aggregate.

According to the invention, the transmission device is in the form of a mechanical transmission device. In addition, in the power path between the drive machine and the auxiliary power take-off aggregate is provided a transmission unit whose transmission ratio is matched to the mechanical transmission device in such manner that the mechanical transmission device can be operated in a main operating range essentially within the range of its maximum efficiency.

With the mechanism according to the invention, compared with systems known from the prior art, an auxiliary power take-off aggregate of a vehicle can be supplied with drive energy more efficiently, since as a rule mechanical continuously variable transmission devices can be operated with higher efficiency than hydraulic continuously variable transmission devices. The additional transmission unit provided also offers the possibility of being able to operate the mechanical continuously variable transmission device, relative to the full operating range of the drive machine, at least close to its maximum efficiency, whereby power losses in the area of the transmission device can be reduced to a minimum and the fuel consumption of a drive machine in the form of an internal combustion engine of a vehicle built with the mechanism according to the invention can be reduced compared with known vehicles such as trucks.

Here, it is particularly advantageous for the transmission ratio of the transmission unit to be chosen such that the rotational speed in the area of the mechanical continuously variable transmission device, which as a statistical average over a mixed route will apply for most of the time, is at the optimum efficiency of the transmission device.

To configure the mechanism according to the invention such that it fits the structural space available in each case with little design complexity, in further advantageous embodiments of the mechanism according to the invention, the transmission device is arranged in the power path between the drive machine and the mechanical transmission device or between the mechanical transmission device and the auxiliary power take-off aggregate.

An also simply designed and inexpensive further embodiment of the mechanism according to the invention is made with a transmission unit which comprises a gearwheel stage having at least two gearwheels that mesh with one another.

In the area of the transmission unit, to compensate for an axial offset between the gearwheels inexpensively and at the same time with little design complexity, in a further development of the mechanism according to the invention the two gearwheels can be brought into functional engagement with one another by means of a coupling element such as a toothed belt or a chain.

In a further advantageous embodiment of the mechanism according to the invention, to avoid undesired power losses in the area of the mechanism when the auxiliary power take-off aggregate is in the switched-off operating condition, the functional connection between the auxiliary power take-off aggregate and the drive machine can be broken, for example by means of a shiftable clutch.

In a further development of the mechanism according to the invention that is space-saving, inexpensive, and that can be operated simply, the transmission unit comprises a planetary gearset with at least three shafts, such that a first shaft of the planetary gearset is functionally connected to the drive machine and to a transmission input shaft of the mechanical continuously variable transmission device, a second shaft of the planetary gearset to a transmission output shaft of the mechanical continuously variable transmission device, and a third shaft of the planetary gearset to the auxiliary power take-off aggregate.

With this last-described embodiment of the mechanism according to the invention, by means of an appropriate, continuously varied adjustment of the transmission ratio in the area of the transmission device a so-termed geared-neutral operating condition can be obtained, during which the speed of the transmission output shaft of the mechanical transmission device is essentially equal to zero. Furthermore, by virtue of the power branching in the area of the planetary gearset, a higher mechanical efficiency can also be obtained.

If in the area of the transmission output shaft, the mechanical transmission device is functionally connected to an electric machine in the area of which drive torque of the drive machine can be converted into electric current for operating the auxiliary power take-off aggregate, in combination with a transmission unit that comprises a planetary gearset, unnecessary zero-load losses in the area of the switched-off electric machine while the electric machine is rotating can be avoided in a simple manner.

If the transmission device is directly mechanically coupled to the auxiliary power take-off aggregate in the area of the transmission output shaft, in a simply designed and inexpensive manner this provides the possibility of supplying the auxiliary power take-off aggregate with drive energy without the electrical components such as an electric machine, rectifier and a further electric machine required in the area of the auxiliary power take-off aggregate.

A particularly space-saving mechanism that can be operated with high efficiency comprises a mechanical transmission device in the form of a toroidal transmission, by means of which the transmission ratio of the transmission device can be continuously varied with high efficiency within a transmission ratio range predetermined by design without axial offset between a transmission input shaft and a transmission output shaft of the transmission device.

Both the characteristics specified in the claims and those indicated in the following example embodiments of the mechanism according to the invention are in each case, whether in isolation or in any desired combination with one another, suitable as further developments of the object of the invention. In relation to the further development of the object of the invention, the respective combinations of characteristics do not represent any limitation but are described essentially only as examples.

Further advantages and advantageous embodiments of the mechanism according to the invention emerge from the claims and from the example embodiments whose principle is described with reference to the drawing wherein, for the sake of clarity, in the description of the various example embodiments the same indexes are used for components with the same structure and function.

### BRIEF DESCRIPTION OF THE DRAWINGS

The drawings show:

FIG. 1: A schematic representation of a first embodiment of the mechanism according to the invention, which is functionally connected to a drive-train of a vehicle;

FIG. 2: A representation corresponding to FIG. 1, showing a second embodiment of the mechanism according to the invention;

FIG. 3: A representation corresponding to FIG. 1, showing a third embodiment of the mechanism according to the invention; and

FIG. 4: Variation of the efficiency of the transmission device of the mechanism shown in FIGS. 1 to 3, as a function of the transmission ratio of the transmission device.

### DETAILED DESCRIPTION OF THE PREFERRED EMBODIMENTS

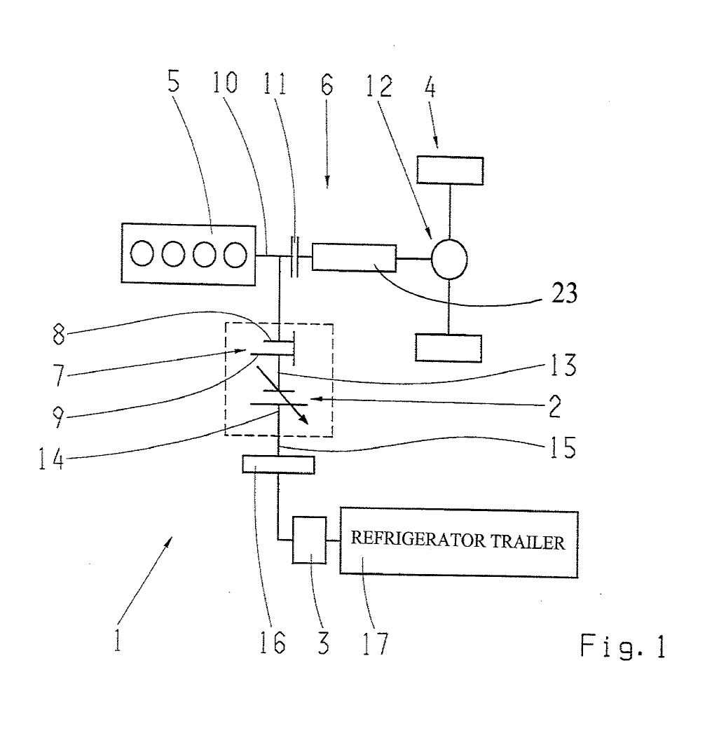

FIG. 1 shows a very schematic representation of a first embodiment of a mechanism 1 with a transmission device 2 for supplying drive energy to at least one auxiliary power take-off aggregate of a vehicle 4, in this case in the form of a cooling aggregate. A transmission ratio of the transmission device 2, which can preferably be designed as a toroidal transmission, can be varied continuously at least over a certain range and the transmission device 2 can be brought into functional connection on its input side with a drive of a drive machine 5 of a drive-train 6 of the vehicle 4 and on its output side with the auxiliary power take-off aggregate 3.

In this case the transmission device 2 is in the form of a mechanical transmission device. In addition, a transmission unit 7 is provided in the power path between the drive machine 5 and the auxiliary power take-off aggregate 3 and whose transmission ratio is adapted to the mechanical transmission device 2 in such manner that the mechanical transmission device 2 can be operated in a main operating range essentially within the range of its maximum efficiency.

The transmission unit 7 comprises two gearwheels 8, 9 that mesh with one another and form a gearwheel stage arranged in the power path between the drive machine 5 and the mechanical transmission device 2. In this case, the gearwheel 8 is connected on the input side to a motor output shaft 10 of the drive machine 5 in the area between the drive machine 5 and a starting clutch 11, so that a drive torque of the drive machine 5 can be transmitted to the gearwheel 8.

In the area of the starting clutch 11, a force flow between the drive machine 5 and a drive output 12 of the drive-train 6 can be interrupted, a transmission 23 being in this case provided between the starting clutch 11 and the output 12, in the area of which various transmission ratios for forward and reverse driving can be engaged depending on the operating status.

In the present case the gearwheel 9 is connected to a transmission input shaft 13 of the mechanical continuously variable transmission device 2, while a transmission output shaft 14 is coupled to a motor shaft 15 of an electric machine 16 that can be operated as a generator. In the area of the electric machine 16 a drive torque of the drive machine 5, appropriately converted in the area of the transmission unit 7 and the transmission device 2, can be transformed into electric current by means of which the auxiliary power take-off aggregate 3 can be operated as necessary. In the area of the electric machine 16, in this case alternating current at a voltage of 380 volts and a frequency of 50 hertz is generated in order to be able, by way of the cooling aggregate 3, to produce an appropriate temperature in the area of a refrigerator trailer 17 of the vehicle 4.

In other embodiments of the mechanism 1, the transmission device 2 can also be made as a wrap-around variator or the like, in order to be able to operate the electric machine 16 over as large an operating range as possible at constant rotational speed independently of the drive input speed of the drive machine 5.

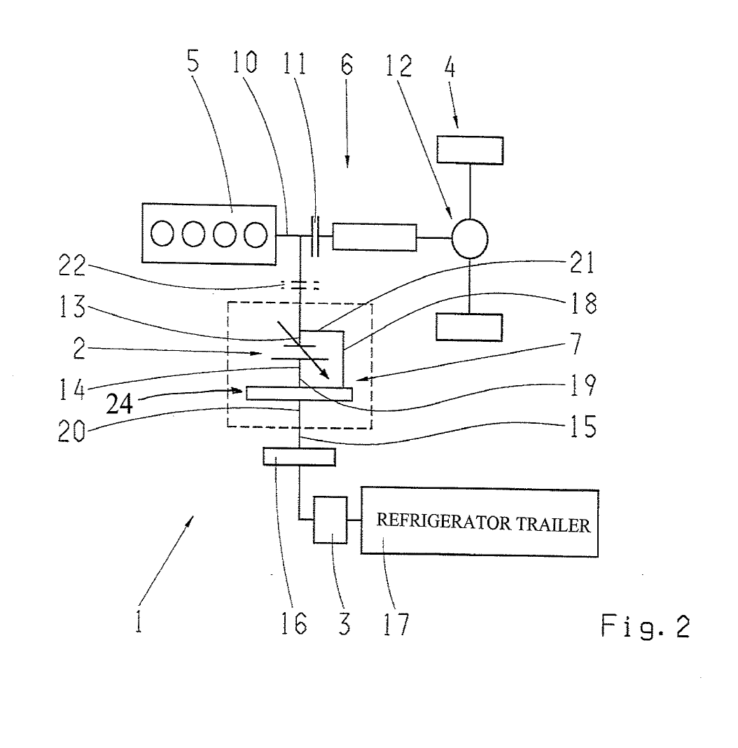

In the second example embodiment of the mechanism 1 shown in FIG. 2 the transmission unit 7 comprises a planetary gearset 24, a first shaft 18 of the planetary gearset 24 being connected to the drive machine 5 and the transmission input shaft 13 of the transmission device 2. A second shaft 19 of the planetary gearset 24 is functionally connected to the transmission output shaft 14 of the transmission device 2 and a third shaft 20 of the planetary gearset 24 to the motor shaft 15 of the electric machine 16 and thus to the auxiliary power take-off aggregate 3. The first shaft 18 of the planetary gearset 24 is in this case coupled by way of a lateral shaft 21 of the transmission device 2 to the transmission input shaft 13 to make it possible, in the switched-off operating condition of the electric machine 16, to obtain a rotational speed of the third shaft 20 of the planetary gearset 24 essentially equal to zero and thereby to avoid needless zero-load losses in the area of the electric machine 16, which occur when the switched-off electric machine 16 is rotating. In addition, by virtue of the planetary gearset 24 by means of which a power branching can be obtained, a higher mechanical efficiency can be achieved than with the embodiment of the mechanism 1 shown in FIG. 1.

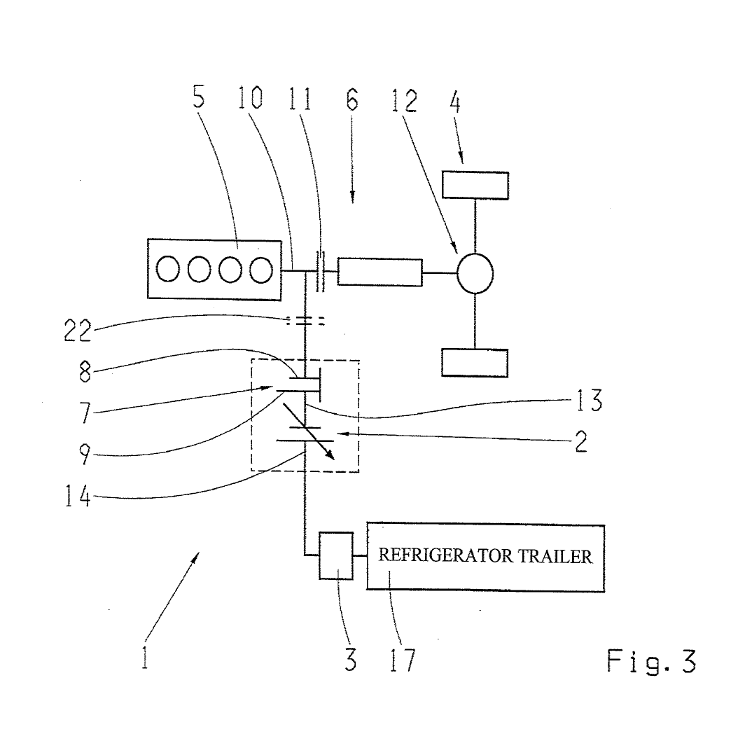

In the third embodiment of the mechanism 1 shown in FIG. 3, the transmission device 2 or its transmission output shaft 14 is mechanically coupled directly to the auxiliary power take-off aggregate 3 when the required fitting space is available in the vehicle 4. The direct mechanical connection of the auxiliary power take-off aggregate 3 in the power path of the drive-train 6 of the vehicle 4 provides, in a simple and inexpensive manner, the possibility of supplying the mechanisms of FIGS. 1 and 2 with appropriate drive energy, without electrical components such as the electric machine 16, a rectifier and a further electric machine needed in the area of the auxiliary power take-off aggregate 3.

To be able also to avoid mechanical losses in the area of the functional connection between the drive-train 6 of the vehicle 4 and the auxiliary power take-off aggregate 3, in further embodiments of the mechanism 1 an optional separating clutch 22 is provided in the area between the motor output shaft 10 and the mechanism 1, by means of which the mechanism 1 can be decoupled from the power flow of the drive-train 6 depending on the operating situation.

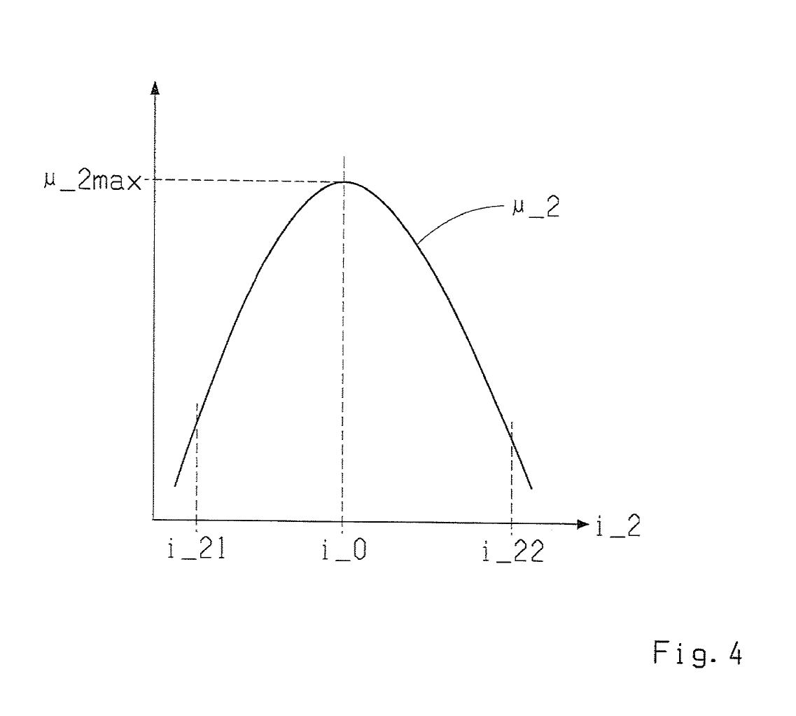

FIG. 4 shows a variation of the efficiency μ_2 of the transmission devices 2 of the mechanisms 1 in FIGS. 1 to 3 as a function of the transmission ratios i_2 of the transmission devices 2. From the representation in FIG. 4 it emerges that the mechanical continuously variable transmission devices 2, in the outside areas of a transmission ratio range delimited by the transmission ratio values i_21 and i_22, within which the transmission ratio i_2 of the transmission devices 2 can be varied continuously, in each case show a steeply decreasing efficiency μ_2. To operate the transmission devices 2 over as large as possible an operating range or rotational speed range of the drive machine 5 at least close to their maximum efficiencies μ_2 max, the transmission ratio of the transmission unit 7 is in each case specified by design in such manner that the speed of the drive machine 5, which as a statistical average over a mixed route applies for the largest proportion of the time, is converted mainly with a transmission ratio of i_0 set in the area of the transmission device 2, at which the transmission device 2 is in each case operated at optimum efficiency μ_2 max.

### INDEXES

1 Mechanism
2 Transmission device
3 Auxiliary power take-off aggregate
4 Vehicle
5 Drive machine
6 Drive-train
7 Transmission unit
8, 9 Gearwheels
10 Motor output shaft
11 Starting clutch
12 Drive output
13 Transmission input shaft
14 Transmission output shaft
15 Motor shaft
16 Electric machine
17 Refrigerator trailer
18 First shaft
19 Second shaft
20 Third shaft
21 Lateral shaft
22 Separator clutch
23 Transmission
24 Planetary gearset
i_2 Transmission ratio of the transmission device
μ_2 Efficiency of the transmission device
μ_2max Maximum efficiency of the transmission device

1-10. (canceled)

11. A mechanism (1) with a transmission device (2) for supplying at least one auxiliary power take-off aggregate (3) of a vehicle (4) with drive energy such that a transmission ratio (i_2) of the transmission device (2) being continuously variable at least over a certain range,
the transmission device (2) being functionally connectable, on an input side, with a drive input of a drive machine (5) of a drive-train (6) of the vehicle and, on an output side, with the auxiliary power take-off aggregate (3),
the transmission device (2) being a mechanical transmission device,
a transmission unit (7) being provided in a power path between the drive machine (5) and the auxiliary power take-off aggregate (3), and
the transmission unit (7) having a transmission ratio adapted to the mechanical transmission device (2) in such manner that, in a main operating range, the mechanical transmission device (2) being operable essentially within a range of its maximum efficiency (μ_2 max).

12. The mechanism according to claim 11, wherein the transmission unit (7) is arranged in the power path one of:
between the drive machine (5) and the mechanical transmission device (2), or
between the mechanical transmission device (2) and the auxiliary power take-off aggregate (3).

13. The mechanism according to claim 11, wherein the transmission unit (7) comprises a gearwheel stage with at least two gearwheels (8, 9) that mesh with one another.

14. The mechanism according to claim 13, wherein the two gearwheels of the transmission unit are functionally connected with one another by way of a coupling element.

15. The mechanism according to claim 14, wherein the coupling element is one of a toothed belt and a chain.

16. The mechanism according to claim 11, wherein the functional connection between the auxiliary power take-off aggregate (3) and the drive machine (5) is interruptable.

17. The mechanism according to claim 11, wherein the transmission unit (7) comprises a planetary gearset with at least first, second and third shafts (18, 19, 20), such that the first shaft (18) of the planetary gearset (24) is functionally connected to the drive machine (5) and to a transmission input shaft (13) of the mechanical transmission device (2), the second shaft (19) of the mechanical transmission device (2) is functionally connected to a transmission output shaft (14) of the mechanical transmission device (2), and the third shaft (20) of the planetary gearset (24) is functionally connected to the auxiliary power take-off aggregate (3).

18. The mechanism according to claim 11, wherein the transmission device (2) is in functional connection with an electric machine (16), in an area where drive torque of the drive machine (5) is transformed into electric current for operating the auxiliary power take-off aggregate (3).

19. The mechanism according to claim 17, wherein the transmission device (2) is mechanically coupled directly to the auxiliary power take-off aggregate (3) in the area of the transmission output shaft (14).

20. The mechanism according to claim 11, wherein the mechanical transmission device (2) is a toroidal transmission.

21. The mechanism according to claim 11, wherein the auxiliary power take-off aggregate (3) is one of a cooling aggregate and a refrigeration aggregate.

22. A mechanism (1) with a mechanical transmission device (2) for supplying at least one auxiliary power take-off aggregate (3) of a vehicle (4) with drive energy such that a transmission ratio (i_2) of the mechanical transmission device (2) being continuously variable at least over a certain range,
an input side of the transmission device (2) being functionally connectable with a drive input of a drive machine (5) of a drive-train (6) of the vehicle while an output side of the transmission device (2) being connected with the auxiliary power take-off aggregate (3),
a transmission unit (7) being provided in a power path between the drive machine (5) and the auxiliary power take-off aggregate (3),
the transmission unit (7) having a transmission ratio adapted to the mechanical transmission device (2) in such manner that, in a main operating range, the mechanical transmission device (2) being operable essentially within a range of its maximum efficiency (μ_2 max), and
the transmission unit (7) being arranged in the power path one of between the drive machine (5) and the mechanical transmission device (2), or between the mechanical transmission device (2) and the auxiliary power take-off aggregate (3).
